(19) United States
(12) Patent Application Publication
(10) Pub. No.: US 2005/0227096 A1
(43) Pub. Date: Oct. 13, 2005

(54) Emulsion with discontinouous phase including particle sol

(76) Inventors: Phil Harding, Albany, OR (US); Palitha Wickramanayake, Corvallis, OR (US); Alexey Kabalnov, Corvallis, OR (US); Niranjan Thirukkovalur, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/819,531

(22) Filed: Apr. 6, 2004

(51) Int. Cl. B32B 15/00; B01F 3/12

(52) U.S. Cl. 428/457; 516/78

(57) ABSTRACT

A composition of matter includes an emulsion with a discontinuous phase of particle sol.

### BACKGROUND

Conductive nanoparticle sols that utilize high-viscosity, oil-based continuous phases to suspend high-density particles may have narrow stability regimes, and the conductive nanoparticles often “crash out”. Furthermore, the high viscosity of the continuous phase makes their use difficult in an inkjet printhead.

Conductive particle sols are difficult to stabilize because of the surface chemistry challenges and density differences. Thus, the particles may settle, thereby creating stability issues, particularly for inkjet applications.

### BRIEF DESCRIPTION OF THE DRAWINGS

Detailed description of embodiments of the invention will be made with reference to the accompanying drawings:

FIG. 1 illustrates how an embodiment of an emulsion including a particle sol provides a quasi-stable colloid even though particles may aggregate and settle within the discontinuous phase of the emulsion;

FIG. 2 is an embodiment of a process flow for formulating an embodiment of an emulsion; and

FIG. 3 illustrates an example embodiment of the formation of printed electronics by dispersing an embodiment of a composition of matter according to an example embodiment.

### DETAILED DESCRIPTION

The following is a detailed description for carrying out embodiments of the invention. This description is not to be taken in a limiting sense, but is made merely for the purpose of illustrating the general principles of the example embodiments of the invention.

According to an embodiment of the present invention, a composition of matter including emulsion with a discontinuous phase of conductive particle sol provides a conductor material for printed electronics that is stable and dispensable. By way of example, but not of limitation, the conductive particles in the sol are <1 μm in size. In various embodiments, the conductive particles in the sol are <500 nm in size. In various embodiments, the conductive particles in the sol are <100 nm in size. The conductive particles in the sol include, for example, nanoparticles. The conductive particles in the sol can include particles other than nanoparticles. The term “colloid” refers to small particles of a discontinuous phase dispersed in a continuous phase. The term “sol” refers to solid particles dispersed in a liquid. The term “emulsion” refers to liquid particles dispersed in a liquid in which it has limited solubility.

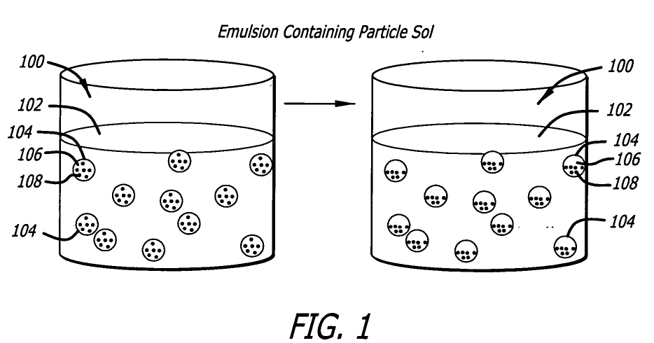

Referring to FIG. 1, an example composition of matter 100 is illustrated. The example composition of matter 100 includes a continuous phase 102 into which a discontinuous phase 104 (e.g., a conductive particle sol 106 including conductive particles 108) is dispersed. In this figure, it should be noted that the liquid drops (of conductive particle sol 106) and the particles 108 are not shown to scale. By way of example, the discontinuous phase 104 is approximately 10-40% volume of the composition of matter 100, and the particles 108 (e.g., silver particles) are approximately 2-6% volume of the composition of matter 100.

According to an embodiment of the present invention, a quasi-stable composition of matter is provided wherein an oil-based sol including particles is emulsified into an aqueous or chemically polar phase. More generally, the particle sol and the phase into which it is emulsified are two substantially immiscible solvents. As illustrated in FIG. 1, this disperses the particles, reducing “crash out” effect. More specifically, the emulsification of the conductive particle sol substantially confines conductive particle aggregation to within the dispersed droplets of conductive particle sol 106, thereby mitigating the undesirable effects of conductive particle aggregation such that the emulsion as a whole remains stable. Confining conductive particle aggregation in this manner serves as a mechanism for buffering against colloidal instability.

Dispersion of the sol also provides a low viscosity vehicle that enables the use of inkjet for the delivery of the material (composition of matter). As discussed below in greater detail, according to various embodiments of the present invention, the volume fraction of the emulsion can be adjusted to the viscosity limitation and the weight fraction of conductive particle can be increased to higher levels (thereby increasing overall content of active ingredient) because the sol stability constraint is relaxed. Moreover, according to various embodiments of the present invention, additives such as surfactants added to alter and modulate particle-particle interactions, examples of which include chlorohexadecanol and Pluronic F68 (available from BASF Corporation of Mount Olive, N.J.), can be used in the continuous phase 102 and/or discontinuous phase 104. Pluronic F68 is a difunctional block copolymer surfactant terminating in primary hydroxyl groups. It is a nonionic surfactant that is 100% active and relatively nontoxic.

Even if the suspension is unstable, emulsifying the unstable sol into an aqueous continuous phase (e.g., of viscosity less than 20 centipoise) provides a quasi-stable colloid which can be stored and delivered using inkjet technology. System stability is influenced by the emulsion stability rather than the sol stability, which provides for increased material stability. The emulsion viscosity is lower than that of the sol because of the aqueous continuous phase. Thus, according to an embodiment of the present invention, a composition of matter includes a discontinuous phase of conductive particle sol and a continuous phase within which the discontinuous phase is suspended. In an embodiment of the present invention, the discontinuous phase is suspended within the continuous phase such that a stability of the composition of matter as a whole is greater than a stability of the conductive particle sol. In an embodiment of the present invention, the discontinuous phase is suspended within the continuous phase such that a viscosity of the composition of matter as a whole is lower than a viscosity of the conductive particle sol.

Further with regard to the conductive particle sol, in an example embodiment, silver nanoparticles (typically 5-50 nm in size) in a solvent-based colloid are used. By way of example, the solvent-based colloid includes alpha-terpineol as the continuous phase solvent plus other cyclic terpene alcohols and terpene hydrocarbons. In an example embodiment, the discontinuous phase 104 can include conductive particle sols such as sols that include alpha-terpineol and silver particles. It should be appreciated, however, that the principles of the present disclosure are not limited to any particular particle system.

According to an example embodiment of the present invention, a composition of matter includes an emulsion with a discontinuous phase of conductive particle sol. It should be appreciated, however, that the principles of the present invention are not limited to conductive particles (such as silver, gold and/or copper particles). Thus, by way of example, the discontinuous phase of particle sol can include conductive particles, semi-conductive particles, insulative particles, dielectric particles and/or other types of particles. It can also include the chemical precursors of the aforementioned materials. The discontinuous phase can also include a surface stabilizer such as chlorohexadecanol. In various embodiments of the present invention, a weight fraction of conductive particles in the conductive particle sol is sufficiently low to maintain a stability of the emulsion as a whole independent of whether a stability of the discontinuous phase is maintained.

According to an example embodiment of the present invention, the discontinuous phase 104 suspended within the continuous phase 102 includes particles in solvent (which include alpha-terpineol, for example). Accordingly, in various embodiments of the present invention, compositions of matter can be described as “colloids within a colloid”. Thus, according to an example embodiment of the present invention, a colloidal system includes colloids formed of conductive particle sol and a mechanism for suspending the colloids within the colloidal system and for buffering against colloidal instability of the conductive particle sol. In various embodiments of the present invention, a weight fraction of conductive particles in the conductive particle sol is sufficiently low to maintain a stability of the colloidal system as a whole independent of whether a stability of the colloids individually is maintained.

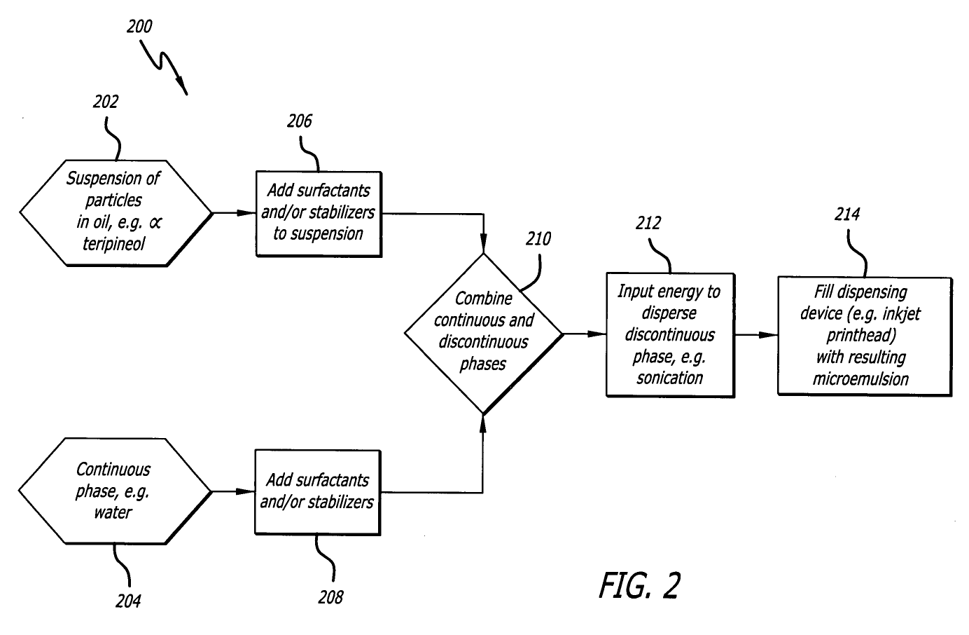

FIG. 2 is a process flow 200 for formulating an emulsion according to an example embodiment of the present invention. At step 202, a suspension of particles in oil, e.g., alpha-terpineol, is provided. At step 204, a continuous phase, e.g., water, is provided. At step 206, surfactants and/or stabilizers are added to the suspension of particles, for example, chlorohexadecanol is added as a surface stabilizer. At step 208, surfactants and/or stabilizers are added to the continuous phase to yield, for example, a continuous phase of water with 10% glycerol (stabilizer) and 3% Pluronic F68 (surfactant). Depending upon the particular formulation and application, steps 306 and/or 308 may be optional. At step 210, the suspension of particles is added into the continuous phase. At step 212, energy is input to disperse the continuous phase. By way of example, a sonication technique or process is employed to input the energy (e.g., 300 Watts for 1-5 minutes). A visual inspection can also be used to determine when the sonication process is completed. At step 214, a dispensing device (e.g., an inkjet printhead) is filled with the resulting microemulsion.

According to an example embodiment of the present invention, a method of making an emulsion includes dispensing conductive particle sol into an aqueous solution and sonicating the conductive particle sol and the aqueous solution to form an emulsion. The sonicating can be performed as a function of various factors including but not limited to: materials characteristics of the conductive particle sol and the aqueous solution, weight ratio of the conductive particle sol and the aqueous solution, surface tension of the conductive particle sol, conductive particle sol viscosity, and aqueous solution viscosity.

According to an example embodiment of the present invention, a method of making an emulsion includes providing a suspension of conductive particles in oil, combining the suspension with a continuous phase liquid within which the suspension is substantially insoluble, and dispersing the suspension into a discontinuous phase within the continuous phase liquid. As discussed above, dispersing the suspension can include employing a sonication technique. In various embodiments of the present invention, dispersing the suspension also includes buffering colloidal instability of the suspension. The method can also include adding a surfactant and/or stabilizer to either or both of the suspension and the continuous phase liquid. According to another example embodiment of the present invention, a method of making a composition of matter includes providing a low viscosity aqueous solution and emulsifying a high viscosity unstable conductive particle sol into the low viscosity aqueous solution to provide a quasi-stable colloid with a viscosity lower than that of the high viscosity unstable conductive particle sol.

According to an example embodiment of the present invention, a method of making an emulsion includes dispensing conductive particle sol into an aqueous solution and forming an emulsion from the conductive particle sol and the aqueous solution such that colloidal instability of the conductive particle sol is buffered. The emulsion can be formed by inputting energy into (e.g., sonicating) the conductive particle sol and the aqueous solution. The method can also include selecting a volume fraction of the conductive particle sol such that a viscosity-for the emulsion is no greater than a desired level of emulsion viscosity. The method can also include adding a surfactant and/or stabilizer to either or both of the conductive particle sol and the aqueous solution.

According to an example embodiment of the present invention, a method of making an emulsion includes dispensing conductive particle sol into an aqueous solution and forming an emulsion from the conductive particle sol and the aqueous solution such that a viscosity of the emulsion is sufficiently low to facilitate delivery of the emulsion using an inkjet technology. The emulsion can be formed by inputting energy into (e.g., sonicating) the conductive particle sol and the aqueous solution. In various embodiments of the present invention, forming the emulsion also includes reducing colloidal instability of the conductive particle sol. The method can also include adding a surfactant and/or stabilizer to either or both of the conductive particle sol and the aqueous solution.

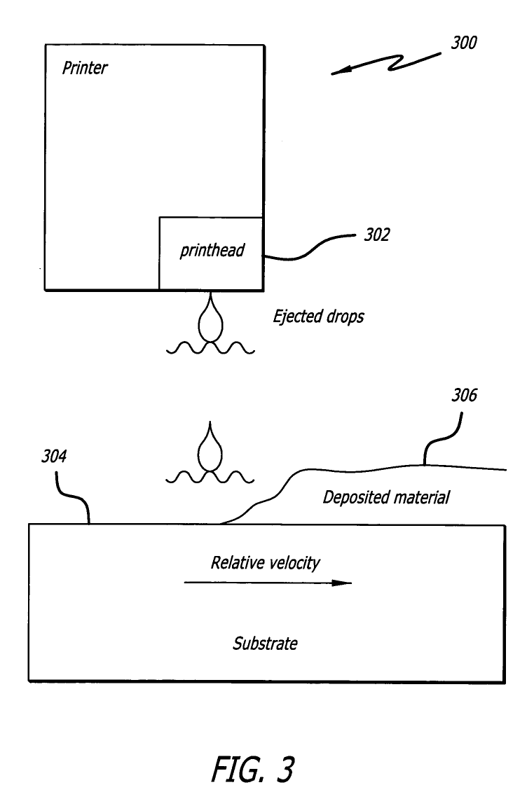

FIG. 3 illustrates the formation of printed electronics by dispersing a composition of matter according to an example embodiment of the present invention. In this example, a composition of matter or emulsion (such as described above) is deposited by ejecting the composition of matter or emulsion from a printhead or pen 302 of a printer 300 onto a substrate 304. By way of example, one or both of the printhead or pen 302 and the substrate 304 are moved relative to each other while the composition of matter or emulsion is ejected (e.g., employing an inkjet technology) from the printhead or pen 302 to form a trace 306 of deposited material on the substrate 304. Thus, according to an example embodiment of the present invention, a process of forming a conductive structure includes providing a substrate and depositing on the substrate an emulsion with a discontinuous phase of conductive particle sol.

When forming conductive structures according to an example embodiment of the present invention with 10% volume discontinuous phase (2 wt % silver), the pen has been observed to startup immediately and appeared robust through several thousand nozzle firings. With 20% volume discontinuous phase (4 wt % silver), the pen started up after a few firings and was robust to about 8,000 nozzle firings.

According to various embodiments of the present invention, the composition of matter or emulsion is deposited to form a conductive structure for an electrical circuit. According to an example embodiment of the present invention, an electrical circuit includes a substrate and a conductive structure formed on the substrate, the conductive structure being formed from an emulsion with a discontinuous phase of conductive particle sol. In other embodiments, the composition of matter or emulsion is deposited to form a conductive, semi-conductive, insulative, dielectric and/or other type of structure for an electrical circuit.

Although embodiments of the present invention have been described in terms of the example embodiments above, numerous modifications and/or additions to the above-described embodiments would be readily apparent to one skilled in the art. It is intended that the scope of the claimed subject matter extends to all such modifications and/or additions.

1. A composition of matter comprising:
an emulsion with a discontinuous phase of conductive particle sol.

2. The composition of matter of claim 1, wherein the emulsion includes two substantially immiscible solvents.

3. The composition of matter of claim 1, wherein the emulsion includes a continuous phase.

4. The composition of matter of claim 3, wherein the continuous phase is aqueous.

5. The composition of matter of claim 3, wherein the continuous phase includes glycerol.

6. The composition of matter of claim 3, wherein the continuous phase includes a surfactant.

7. The composition of matter of claim 6, wherein the surfactant is a polymer.

8. The composition of matter of claim 6, wherein the surfactant is nonionic.

9. The composition of matter of claim 3, wherein the continuous phase includes a difunctional block copolymer surfactant.

10. The composition of matter of claim 1, wherein the discontinuous phase is oil-based.

11. The composition of matter of claim 1, wherein the discontinuous phase includes alpha-terpineol.

12. The composition of matter of claim 1, wherein the discontinuous phase includes a surface stabilizer.

13. The composition of matter of claim 12, wherein the surface stabilizer is chlorohexadecanol.

14. The composition of matter of claim 1, wherein a weight fraction of conductive particles in the conductive particle sol is sufficiently low to maintain a stability of the emulsion as a whole independent of whether a stability of the discontinuous phase is maintained.

15. The composition of matter of claim 1, wherein the conductive particle sol includes silver particles.

16. The composition of matter of claim 1, wherein the conductive particle sol includes gold particles.

17. The composition of matter of claim 1, wherein the conductive particle sol includes copper particles.

18. The composition of matter of claim 1, wherein the conductive particle sol includes nanoparticles.

19. A colloidal system comprising:
colloids formed of conductive particle sol; and
means for suspending the colloids within the colloidal system and for buffering against colloidal instability of the conductive particle sol.

20. The colloidal system of claim 19, wherein the colloids are oil-based.

21. The colloidal system of claim 19, wherein the colloids include alpha-terpineol.

22. The colloidal system of claim 19, wherein the colloids include a surface stabilizer.

23. The colloidal system of claim 22, wherein the surface stabilizer is chlorohexadecanol.

24. The colloidal system of claim 19, wherein a weight fraction of conductive particles in the conductive particle sol is sufficiently low to maintain a stability of the colloidal system as a whole independent of whether a stability of the colloids individually is maintained.

25. The colloidal system of claim 19, wherein the conductive particle sol includes silver particles.

26. The colloidal system of claim 19, wherein the conductive particle sol includes gold particles.

27. The colloidal system of claim 19, wherein the conductive particle sol includes copper particles.

28. The colloidal system of claim 19, wherein the conductive particle sol includes nanoparticles.

29. A composition of matter comprising:
a discontinuous phase of conductive particle sol; and
a continuous phase within which the discontinuous phase is suspended.

30. The composition of matter of claim 29, wherein the discontinuous phase is suspended within the continuous phase such that a stability of the composition of matter as a whole is greater than a stability of the conductive particle sol.

31. The composition of matter of claim 29, wherein the discontinuous phase is suspended within the continuous phase such that a viscosity of the composition of matter as a whole is lower than a viscosity of the conductive particle sol.

32. The composition of matter of claim 29, wherein the discontinuous phase is oil-based.

33. The composition of matter of claim 29, wherein the discontinuous phase includes alpha-terpineol.

34. The composition of matter of claim 29, wherein the discontinuous phase includes a surface stabilizer.

35. The composition of matter of claim 34, wherein the surface stabilizer is chlorohexadecanol.

36. The composition of matter of claim 29, wherein the discontinuous phase is approximately 10-40% volume of the composition of matter.

37. The composition of matter of claim 29, wherein the conductive particle sol includes silver particles.

38. The composition of matter of claim 37, wherein the silver particles are approximately 2-6% volume of the composition of matter.

39. The composition of matter of claim 29, wherein the conductive particle sol includes gold particles.

40. The composition of matter of claim 29, wherein the conductive particle sol includes copper particles.

41. The composition of matter of claim 29, wherein the conductive particle sol includes nanoparticles.

42. The composition of matter of claim 29, wherein the continuous phase is aqueous.

43. The composition of matter of claim 29, wherein the continuous phase includes glycerol.

44. The composition of matter of claim 29, wherein the continuous phase includes a surfactant.

45. The composition of matter of claim 44, wherein the surfactant is a polymer.

46. The composition of matter of claim 44, wherein the surfactant is nonionic.

47. The composition of matter of claim 29, wherein the continuous phase includes a difunctional block copolymer surfactant.

48. A method of making an emulsion comprising:
dispensing conductive particle sol into a continuous phase; and
forming an emulsion from the conductive particle sol and the continuous phase such that colloidal instability of the conductive particle sol is buffered.

49. The method of making an emulsion of claim 48, wherein forming an emulsion includes inputting energy into the conductive particle sol and the continuous phase.

50. The method of making an emulsion of claim 48, wherein inputting energy includes sonicating the conductive particle sol and the continuous phase.

51. The method of making an emulsion of claim 48, further comprising:
selecting a volume fraction of the conductive particle sol such that a viscosity for the emulsion no greater than a maximum acceptable emulsion viscosity.

52. The method of making an emulsion of claim 48, further comprising:
adding a surfactant to the conductive particle sol.

53. The method of making an emulsion of claim 48, further comprising:
adding a stabilizer to the conductive particle sol.

54. The method of making an emulsion of claim 48, further comprising:
adding a surfactant to the continuous phase.

55. The method of making an emulsion of claim 48, further comprising:
adding a stabilizer to the continuous phase.

56. A method of making an emulsion comprising:
dispensing conductive particle sol into a continuous phase; and
forming an emulsion from the conductive particle sol and the continuous phase such that a viscosity of the emulsion is sufficiently low to facilitate delivery of the emulsion using an inkjet technology.

57. The method of making an emulsion of claim 56, wherein forming an emulsion includes inputting energy into the conductive particle sol and the continuous phase.

58. The method of making an emulsion of claim 57, wherein inputting energy includes sonicating the conductive particle sol and the continuous phase.

59. The method of making an emulsion of claim 56, wherein forming an emulsion includes buffering colloidal instability of the conductive particle sol.

60. The method of making an emulsion of claim 56, further comprising:
adding a surfactant to the conductive particle sol.

61. The method of making an emulsion of claim 56, further comprising:
adding a stabilizer to the conductive particle sol.

62. The method of making an emulsion of claim 56, further comprising:
adding a surfactant to the continuous phase.

63. The method of making an emulsion of claim 56, further comprising:
adding a stabilizer to the continuous phase.

64. A method of making a composition of matter comprising:
providing a low viscosity continuous phase; and
emulsifying a high viscosity unstable conductive particle sol into the low viscosity continuous phase to provide a quasi-stable colloid with a viscosity lower than that of the high viscosity unstable conductive particle sol.

65. The method of making a composition of matter of claim 64, wherein emulsifying includes employing a sonication technique.

66. The method of making a composition of matter of claim 64, further comprising:
adding a surfactant to the high viscosity unstable conductive particle sol.

67. The method of making a composition of matter of claim 64, further comprising:
adding a stabilizer to the high viscosity unstable conductive particle sol.

68. The method of making a composition of matter of claim 64, further comprising:
adding a surfactant to the low viscosity continuous phase.

69. The method of making a composition of matter of claim 64, further comprising:
adding a stabilizer to the low viscosity continuous phase.

70. A method of making an emulsion comprising:
dispensing conductive particle sol into a continuous phase; and
sonicating the conductive particle sol and the continuous phase to form an emulsion.

71. The method of making an emulsion of claim 70, wherein the sonicating is performed as a function of materials characteristics of the conductive particle sol and the continuous phase.

72. The method of making an emulsion of claim 70, wherein the sonicating is performed as a function of a weight ratio of the conductive particle sol and the continuous phase.

73. The method of making an emulsion of claim 70, wherein the sonicating is performed as a function of a surface tension of the conductive particle sol.

74. The method of making an emulsion of claim 70, wherein the sonicating is performed as a function of conductive particle sol viscosity.

75. The method of making an emulsion of claim 70, wherein the sonicating is performed as a function of continuous phase viscosity.

76. A method of making an emulsion comprising:
providing a suspension of conductive particles in oil;
combining the suspension with a continuous phase liquid within which the suspension is substantially insoluble; and
dispersing the suspension into a discontinuous phase within the continuous phase liquid.

77. The method of making an emulsion of claim 76, wherein dispersing the suspension includes employing a sonication technique.

78. The method of making an emulsion of claim 76, wherein dispersing the suspension includes buffering colloidal instability of the suspension.

79. The method of making an emulsion of claim 76, further comprising:
adding a surfactant to the suspension.

80. The method of making an emulsion of claim 76, further comprising:
adding a stabilizer to the suspension.

81. The method of making an emulsion of claim 76, further comprising:
adding a surfactant to the continuous phase liquid.

82. The method of making an emulsion of claim 76, further comprising:
adding a stabilizer to the continuous phase liquid.

83. A process of forming a conductive structure comprising:
providing a substrate; and
depositing on the substrate an emulsion with a discontinuous phase of conductive particle sol.

84. The process of forming a conductive structure of claim 83, wherein the emulsion is deposited by ejecting the emulsion from a printhead of a printer.

85. The process of forming a conductive structure of claim 83, wherein the emulsion is deposited by inkjetting.

86. The process of forming a conductive structure of claim 83, wherein the emulsion is deposited to form a conductive structure for an electrical circuit.

87. An electrical circuit comprising:
a substrate; and
a conductive structure formed on the substrate, the conductive structure being formed from an emulsion with a discontinuous phase of conductive particle sol.

88. The electrical circuit of claim 87, wherein the emulsion is aqueous.

89. The electrical circuit of claim 87, wherein the conductive particle-sol includes silver particles.

90. The electrical circuit of claim 87, wherein the conductive particle sol includes gold particles.

91. The electrical circuit of claim 87, wherein the conductive particle sol includes copper particles.

92. The electrical circuit of claim 87, wherein the conductive particle sol includes nanoparticles.

93. A composition of matter comprising:
an emulsion with a discontinuous phase of particle sol that includes conductive particles.

94. A composition of matter comprising:
an emulsion with a discontinuous phase of particle sol that includes semi-conductive particles.

95. A composition of matter comprising:
an emulsion with a discontinuous phase of particle sol that includes insulative particles.

96. A composition of matter comprising:
an emulsion with a discontinuous phase of particle sol that includes dielectric particles.
